(19) United States
(12) Patent Application Publication
(10) Pub. No.: US 2005/0115416 A1
(43) Pub. Date: Jun. 2, 2005

(54) Conveyor for a food portion-producing machine

(76) Inventor: James E. Pasek, Mokena, IL (US)

Correspondence Address: THE LAW OFFICE OF RANDALL T. ERICKSON, P.C., 425 WEST WESLEY STREET, SUITE 1, WHEATON, IL, 60187, US

(21) Appl. No.: 10/973,574

(22) Filed: Oct. 26, 2004

Related U.S. Application Data
(60) Provisional application No. 60/515,106, filed on Oct. 28, 2003.

(51) Int. Cl. A21C 9/06

(52) U.S. Cl. 99/386

(57) ABSTRACT

A conveyor for a patty-forming apparatus is supported in cantilever fashion on support rods from the patty-forming apparatus. The conveyor includes an easily operated toggle mechanism to elevate the conveyor at a downstream end to facilitate sliding displacement of at least a portion of the conveyor on the support rods to gain access to portions of the apparatus. Particularly, the invention provides a lever action mechanism that tips the conveyor to raise a discharge end of conveyor. This mechanism facilitates sliding the conveyor out for access to knockout plungers of the apparatus. Elevation adjustment assemblies are arranged between the conveyor and the support rods. The set of the elevation assemblies is not affected by operation of the toggle mechanism.

This application claims the benefit of U.S. Provisional Application 60/515,106 filed Oct. 28, 2003.

### TECHNICAL FIELD OF THE INVENTION

The invention relates to conveyors for food portion producing machines, particularly for reciprocating mold plate patty-forming machines.

### BACKGROUND OF THE INVENTION

A complete description of patty-forming machines can be found in U.S. Patent RE 30,096, U.S. patent application Ser. No. 60/503,354, filed Sep. 16, 2003, and U.S. patent application Ser. No. 10/942,627, filed on Sep. 16, 2004, all herein incorporated by reference. Patty-forming machines are also commercially available as FORMAX F-6, F-12, F-19, F-26, F-400 and MAXUM700 machines, from Formax, Inc., of Mokena, Ill., U.S.A.

Beneath the discharge end of a patty-forming machine, and particularly beneath the knock out cups of a reciprocating mold plate patty-forming machine, a conveyor is arranged to receive the patties discharged from the mold plate. The conveyor is typically a stand-alone conveyor and supported from the floor on legs, and operates to discharge the patties to a downstream conveyor, freezer, packaging apparatus, or other downstream device.

In such an arrangement, in order to maintain, retool, repair or clean the knock out end of the patty-forming apparatus, it is advantageous if the conveyor can be moved away from the knock out end. When the conveyor is reinstalled, typically both ends, and both sides, of the conveyor must be leveled and height-adjusted to maintain the correct relationship to adjacent upstream and downstream equipment.

The present inventor has recognized that it would be advantageous to provide a conveyor that was easily moved to access adjacent equipment. The present inventor has recognized that would be advantageous to provide a conveyor that was easily movable to access adjacent equipment for maintenance and was easily placed back into correct operating position with regard to both the upstream and downstream equipment, without the need to readjust the elevation and leveling of the conveyor.

### SUMMARY OF THE INVENTION

The present invention provides an improved output conveyor for a food product-producing apparatus, such as a patty-forming apparatus. The conveyor is supported in cantilever fashion from the food product-producing apparatus. The conveyor includes an easily operated mechanism to elevate the conveyor at a downstream end to facilitate sliding removal of at least a portion of the conveyor to gain access to portions of the apparatus. Particularly, the invention provides a lever action mechanism that tips the conveyor to raise a discharge end of conveyor. This lever action mechanism facilitates sliding the conveyor outward for access to the output area of the apparatus.

This mechanism also makes it easier to move downstream conveyors or systems without interference with the output conveyor.

By using a fixed displacement toggling mechanism, once elevation and leveling of the conveyor is established, a re-establishing of heights need not be done after the output conveyor is moved from a maintenance position back into an operating position, i.e., the elevation and leveling of the conveyor does not have to be re-adjusted every time the output conveyor is moved away from the machine.

When the food product-producing apparatus is a patty-forming apparatus, the conveyor can be slid away from a knockout area of the apparatus. As a further aspect of the invention, a knockout guard is pivotally mounted to the output conveyor to be moved with the output conveyor. The output conveyor can be slid away from the patty-forming apparatus, and folded away from the patty-forming apparatus, providing more access to the knockout plungers for tooling changes, repairs, adjustments, clean-up, and maintenance.

As a further aspect of the invention, the output conveyor includes elevation adjustment assemblies to independently adjust the elevation of an input end of the conveyor and the elevation of an output end of the conveyor. Thus, the distance the patty drops onto the conveyor at the input end can be adjusted and the output end can be adjusted to match the downstream equipment.

As a further aspect of the invention, the conveyor includes a drum motor drive that is easier to clean than external motors, reducers, chains or other power transmission devices.

Numerous other advantages and features of the present invention will be become readily apparent from the following detailed description of the invention and the embodiments thereof, and from the accompanying drawings.

### BRIEF DESCRIPTION OF THE DRAWINGS

FIG. 1 is a diagrammatic, elevational view of a patty-forming machine incorporating the conveyor of the present invention, with some panels and/or components removed for clarity;

FIG. 2 is an enlarged, fragmentary view taken from FIG. 1;

FIG. 3 is an enlarged, fragmentary view taken from FIG. 2;

FIG. 4 is a diagrammatic elevational view of the patty-forming apparatus of FIG. 1, with the conveyor and in an extended, maintenance position, with some panels and/or components removed for clarity;

FIG. 4A is an enlarged, fragmentary view taken from FIG. 4, with the conveyor shown tilted down at its discharge end;

FIG. 4B is an enlarged fragmentary view taken from FIG. 4, with the conveyor shown tilted up at its discharge end;

FIG. 4C is an enlarged, fragmentary view taken from FIG. 4A;

FIG. 5 is a sectional view taken generally along line 5-5 of FIG. 4C, with some panels and/or components removed for clarity;

FIG. 6 is a sectional view taken generally along line 6-6 of FIG. 4C, with some panels and/or components removed for clarity;

FIG. 7 is a is a sectional view taken generally along line 7-7 of FIG. 4C, with some panels and/or components removed for clarity;

FIG. 8 is a sectional view taken generally along line 8-8 of FIG. 4C, with some panels and/or components removed for clarity;

FIG. 9 is a sectional view taken generally along line 9-9 of FIG. 4C, with some panels and/or components removed for clarity;

FIG. 10 is a plan view of the conveyor taken generally along line 10-10 of FIG. 2, with some panels and/or components removed for clarity;

FIG. 11 is a sectional view of the conveyor taken generally along line 11-11 of FIG. 2, with some panels and/or components removed for clarity; and

FIG. 12 is a sectional view taken generally through line 12-12 of FIG. 10, with some panels and/or components removed for clarity.

### DETAILED DESCRIPTION OF THE PREFERRED EMBODIMENTS

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

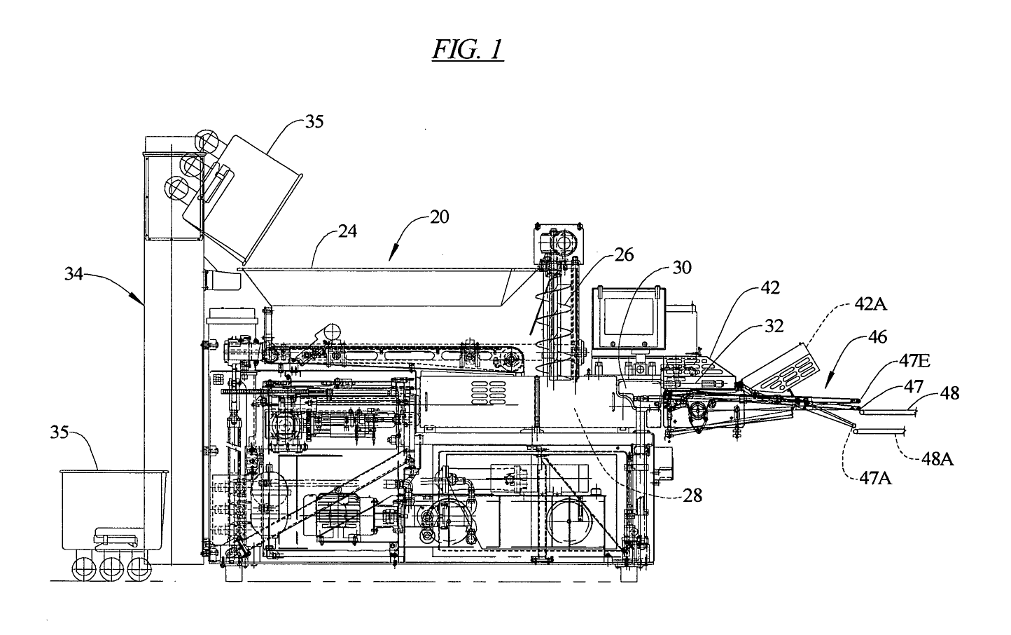

FIG. 1 illustrates a patty-forming apparatus 20. A complete description of patty-forming machines can be found in U.S. patent RE 30,096, U.S. patent application Ser. No. 60/503,354, filed Sep. 16, 2003, and U.S. patent application Ser. No. 10/942,627, filed on Sep. 16, 2004, all herein incorporated by reference. The apparatus 20 has a bin or hopper 24 for holding a supply of food material. Augers 26 deliver the food material into a food pump 28 which pumps food material through a manifold 30 and into cavities of a reciprocating mold plate 32. A powered bucket lift 34 lifts buckets 35 containing food material and discharges the content of the buckets into the hopper 24.

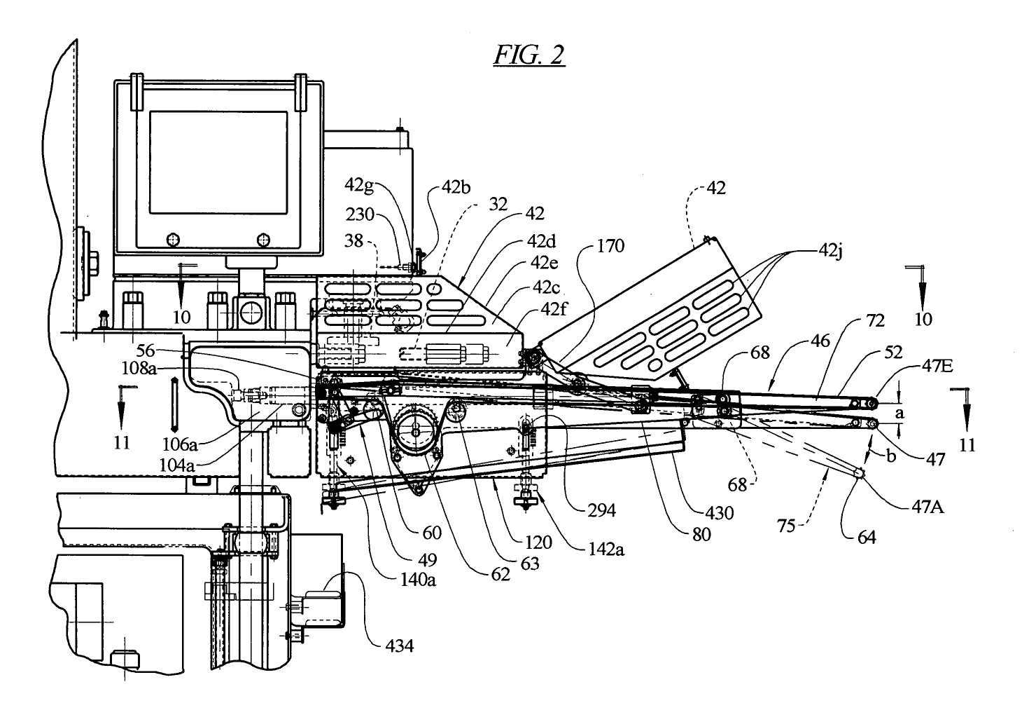

The patties are discharged from the cavities of the mold plate 32 by vertically reciprocating knock out plungers or cups 38 (see FIG. 2), located behind a guard 42. The patties are deposited onto an output conveyor 46 to be transported to the discharge or output end 47 thereof, to be delivered to another conveyor 48, or to another piece of equipment.

Also shown in FIG. 1 is the conveyor 46 having a lowered discharge end 47A that is angled to match an input end of the conveyor 48 being at a lower position 48A. An elevated position 47E of the conveyor end 47 is also shown. The elevated position is used to slide the conveyor 46 away from the patty-forming apparatus and partly over the conveyor 48, or other equipment, to gain access to the knock out cups 38 and the corresponding area of the apparatus 20 for maintenance, cleaning, repair or retooling.

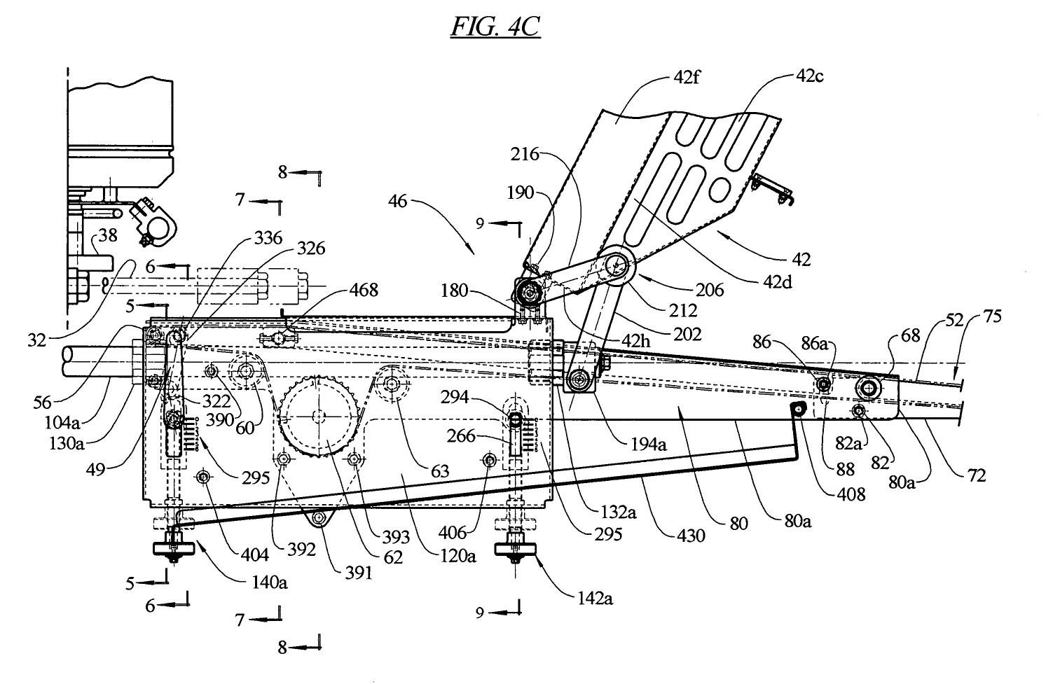

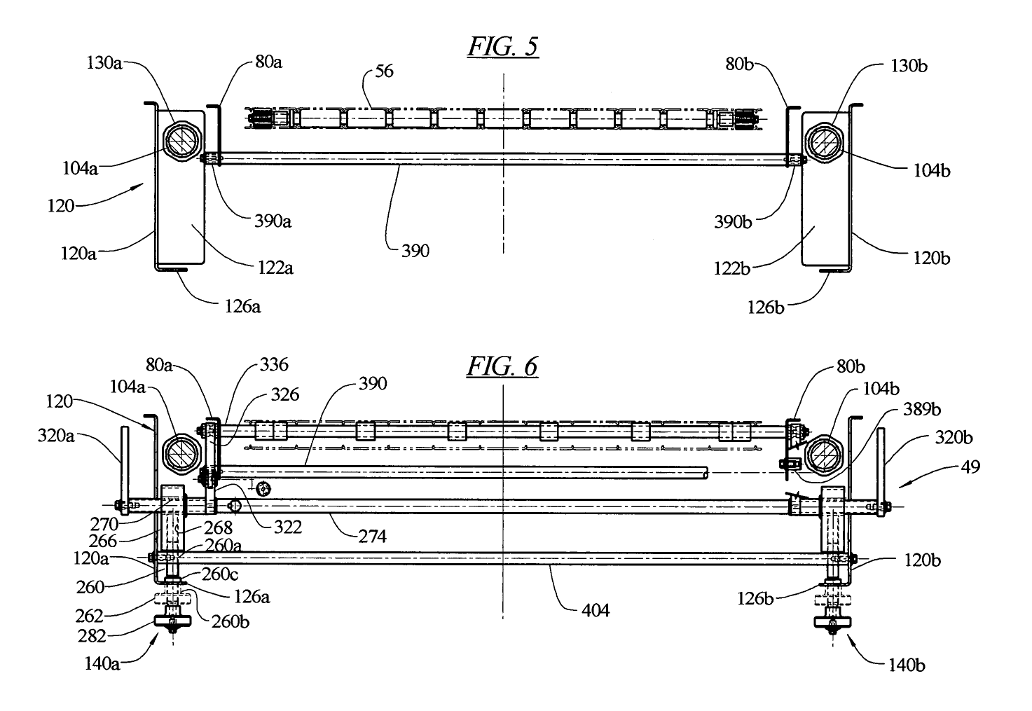

FIGS. 2 through 12 illustrate the conveyor 46 in more detail. Portions of the conveyor 46, such as frame sidewalls are shown transparent or removed for clarity. The conveyor 46 is operable over an angular range “b” at its discharge end 47 from the position shown as 47 to the position shown as 47A. The conveyor 46 includes a rear toggle or lever arrangement 49, described below, which allows the conveyor end 47 to shift from any fixed position throughout the angle “b” to an elevated position 47E that is the distance “a” higher than the particular operating position. According to the preferred embodiment the distance “a” is about 2 inches, preferably 1.8 inches.

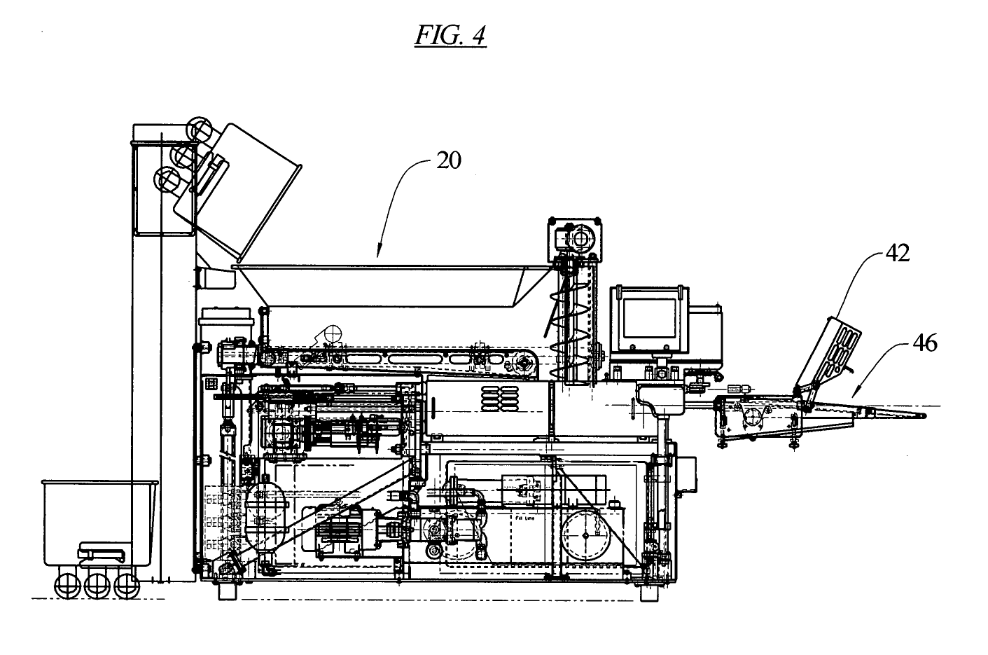

As illustrated in FIGS. 2 and 4C, the conveyor 46 comprises a continuous wire belt 52 such as one provided by The Wire Belt Company of America. The belt 52 is circulated around a rear roller 56, a bottom first roller 60, a drum motor 62, a bottom second roller 63, a front roller 64 and an intermediate roller 68. The intermediate roller 68 is carried by a front frame 72. The frame 72 is selectively angled to lower the front roller 64, such that a front portion 75 of the belt 52, between the intermediate roller 68 and the front roller 64, can be set at the desired angle.

The drum motor 62 can be a DURA-DRIVE Drum Motor available from Sparks Belting Company, of Grand Rapids, Mich., U.S.A.

The rear roller 56, the bottom roller 60, the drum motor 62, and the bottom second roller 63 are carried by sidewalls 80a, 80b of an inside conveyor frame 80. The bottom roller 60, the drum motor 62, and the bottom second roller 63 are mounted directly onto the sidewalls 80a, 80b.

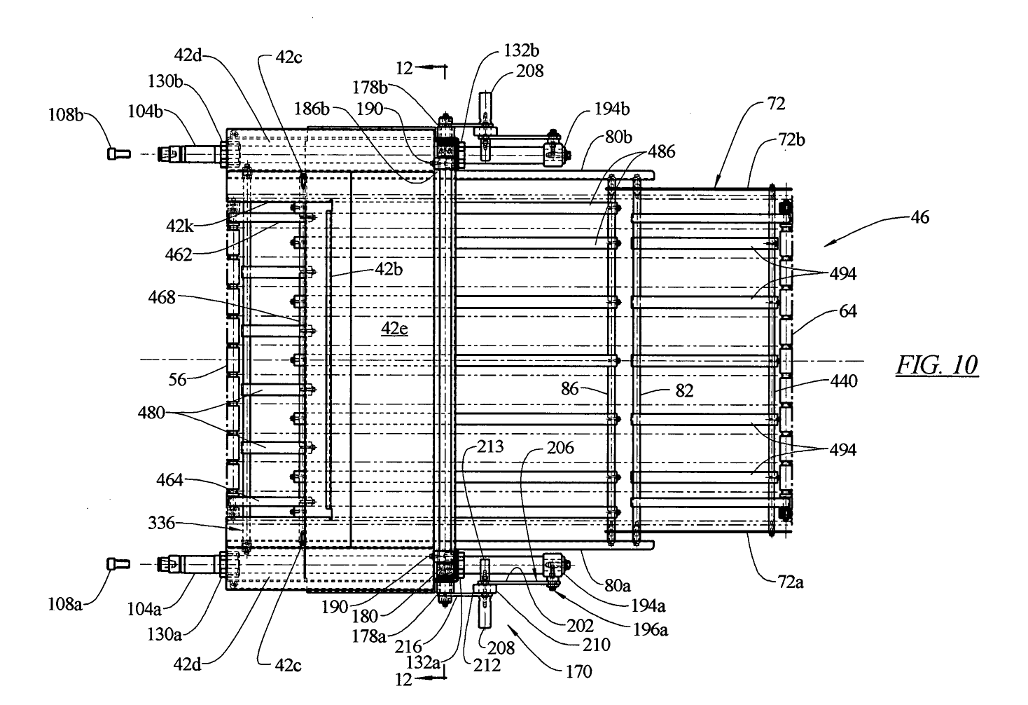

Referring to FIGS. 4C and 10, the front frame 72 is fastened to the sidewalls 80a, 80b of the inside frame 80 by a pivot strut 82 and an angle-set strut 86. The struts 82, 86 have opposite end tapped holes that receive fasteners 82a, 86a. The struts 82, 86 are received through apertures through the front frame 72. The struts 82, 86 are tubes or rods and have a lesser outside diameters than the apertures through the front frame 72. The struts abut an inside face of the inside frame 80 on each sidewall 80a, 80b, in registry with an aperture and a curved slot 88 on each sidewall 80a, 80b. The strut 82 has a greater outside diameter than the aperture through the inside frame sidewalls 80a, 80b and the strut 86 has an outside diameter greater than a width of the curved slot 88 through the inside frame sidewalls 80a, 80b. The pivot fasteners 82a capture both sidewalls 80a, 80b of the inside frame 80 between the head of the respective pivot fastener 82a and the strut 82. The angle-set fasteners 86a capture the sidewalls 80a, 80b of the inside frame 80 between the head of the respective angle-set fastener 86a and the strut 86, at a selected position in the curved slot 88. Thus the fasteners 82a, 86a can be loosened and the angle of the front frame 72 can be set with respect to the inside frame 80.

Referring to FIGS. 2 and 10, the conveyor 46 is supported by parallel, longitudinally extended horizontal support rods 104a, 104b. The rods 104a, 104b are fixed into base blocks 106a, 106b on the machine frame and secured thereto by fasteners 108a, 108b. The base blocks 106a, 106b support the rods 104a, 104b in cantilever fashion.

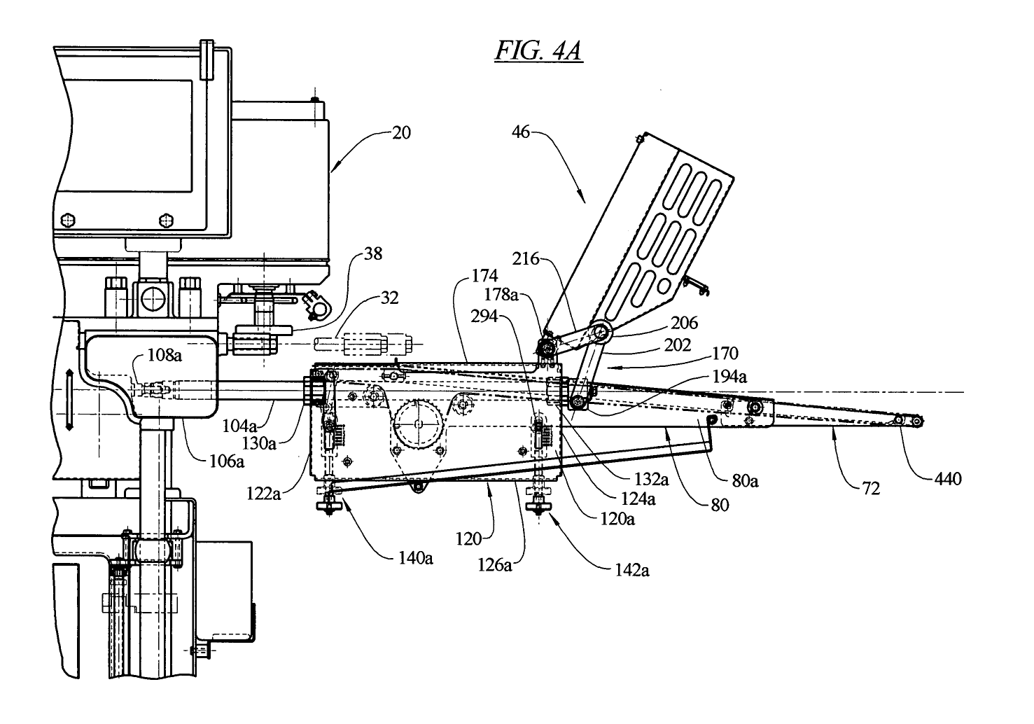

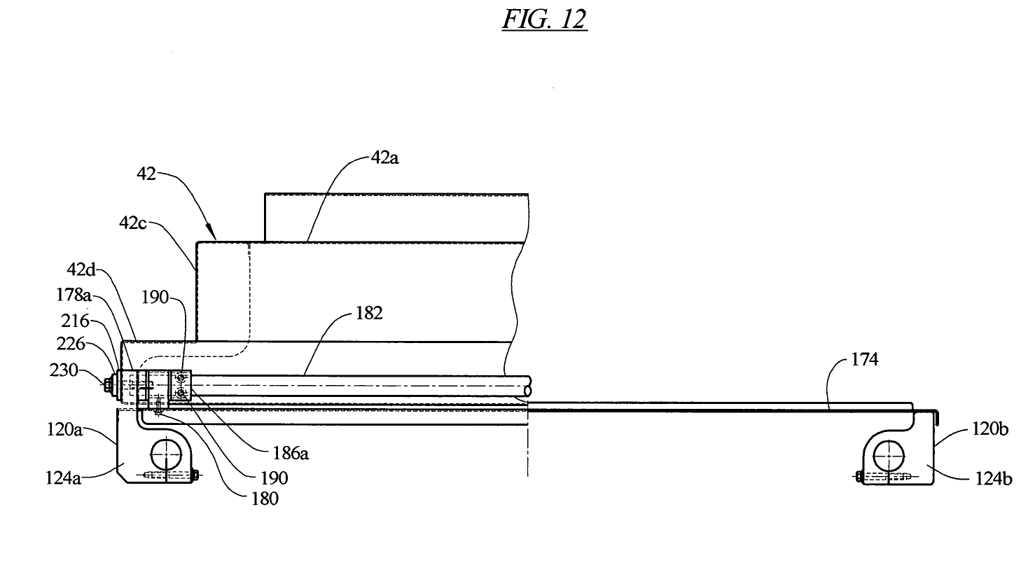

The conveyer 46 has an outer frame 120 having sidewalls 120a, 120b having inwardly directed rear flanges 122a, 122b as shown in FIG. 5, inwardly directed front flanges 124a, 124b as shown in FIG. 12, and inwardly directed bottom flanges 126a, 126b, as shown in FIGS. 5-9.

Referring to FIGS. 4A and 10, the rear flanges 122a, 122b carry rear slide bearings 130a, 130b and the front flanges 124a, 124b carry front slide bearings 132a, 132b. The slide bearings 130a, 132a journal sliding movement of the conveyor on the rod 104a and the slide bearings 130b, 132b journal sliding movement of the conveyor on the rod 104b.

Referring to FIGS. 2, 6 and 9, the inside frame 80 is supported on the outside frame 120 via rear elevation adjustment assemblies 140a, 140b and front elevation adjustment assemblies 142a, 142b, described below.

Referring to FIGS. 2 and 10, a front toggle or lever assembly 170 is used to slide the conveyor 46 on the rods 104a, 104b.

Referring to FIGS. 4C, 10-12, a drip pan 174 is fixed to the outer frame sidewalls 120a, 120b. A respective pivot connection 178a, 178b is mounted on the pan 174 or otherwise connected to the sidewalls 120a, 120b, via fasteners 180. The pivot connections journal opposite ends of a hinge rod 182. The guard 42 is hingedly attached to the hinge rod 182 via hinge journals 186a, 186b that are attached to the guard 42 by fasteners 190. The guard 42 can pivot freely on the hinge rod 182.

The front toggle or lever assembly 170 includes rod fixtures 194a, 194b fixed onto ends of the rods 104a, 104b. Each fixture 194a, 194b includes a laterally oriented pivot connection 196 created and retained by a fastener 196a. Each first link 202 extends from the pivot connection 196 to a handle assembly 206. Each handle assembly includes a handle 208, a pivot connection 210, a rest 212, and an extension 213. The pivot connection connects the handle 210, the rest 212 and the extension 213 to the first link 202 and to a second link 216. A fastener 220 creates and retains the pivot connection 210.

Each second link 216 is pivotally connected to the respective pivot connection 178a, 178b by a retainer 226 and a fastener 230. The fastener 230 is engaged into an end of the hinge rod 182 and, together with the retainer 226 retains second link 216 at the respective pivot connection 178a, 178b.

By grasping both handles 208 on opposite sides of the conveyor 46 and exerting a force forwardly, the conveyor can be extended to its maintenance position as shown in FIGS. 4-4C. The links 202, 206 fold into a “7” shape as shown, as the outside frame 120, and thus the inside frame 80 also, slides on the rods 104a, 104b forwardly until contact is made between the bearings 132a, 132b and the rod fixtures 194a, 194b on the rods 104a, 104b.

When the conveyor 46 is slid rearward to an operating position, and the guard is swung down to its operating position as shown in FIG. 2, the toggle assembly 170 assumes the locked position shown in FIG. 2 with the links 202, 216 assuming an over center locked orientation. The extensions 213 contact the rods 104a, 104b which act as stops for the toggle assembly, as shown in FIGS. 2 and 10.

In the position shown in FIG. 4C, the guard 42 can be opened and supported as shown with the shoulders 42d resting on the rests 212.

Referring to FIGS. 2, 4C, 10 and 12, the guard 42 includes a top wall 42a, a flange 42b extending above the top wall 42a, upper sidewalls 42c, side shoulders 42d, an inclined front wall 42e, a straight front wall 42h, and lower sidewalls 42f. The guard is configured in mirror image fashion about a longitudinal centerline. The flange 42b includes a target 42g for being sensed by a sensor 230 to determine in machine control whether or not the guard 42 is in position.

The top wall 42a includes a rectangular cutout 42k (FIG. 10) corresponding generally to the knockout area. The upper sidewalls 42c include oblong openings 42j (FIG. 2). All other portions 42d, 42e, 42h, and 42f of the guard 42 are substantially solid.

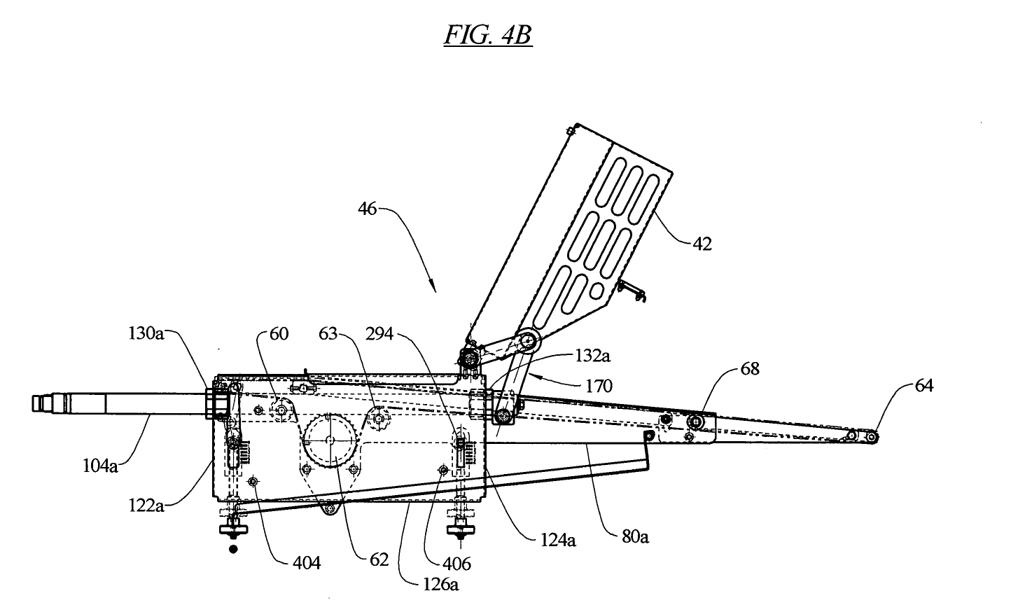

Each elevation adjustment assembly 140a, 142a, 140b, 142b is configured essentially the same. As an example, the assembly 140a will be explained. Referring to FIG. 6, the elevation adjustment assembly 140a includes a threaded rod 260, having threads in a first region 260a and a second region 260b. A locking knob 262 is threaded onto the region 260b. A yoke 266, which can be in block or cylinder form, has a threaded bore 268 threaded onto the region 260a. The yoke has a cross bore 270 for receiving a rod 274. The rod 274 is supported at its opposite end by the elevation adjustment assembly 140b. The rod 274 supports a rear portion of the inside frame 80. An adjustment knob 282 is rotationally fixed to an end of the threaded rod 260 to turn the threaded rod by hand.

The threaded rod 260 includes a shoulder portion 260c adjacent to the flange 126a of the outside frame 120. When elevation adjustments are completed, the locking knob 262 can be elevated on the threaded region 260b by turning the knob 262 while holding the adjustment knob 282 to prevent the rod 260 from turning. The locking knob 262 is elevated until the flange 126a is tightly clamped between the shoulder portion 260c of the threaded rod 260 and the locking knob 262. The threaded rod rotary position is thus locked and prevented from changing during operation.

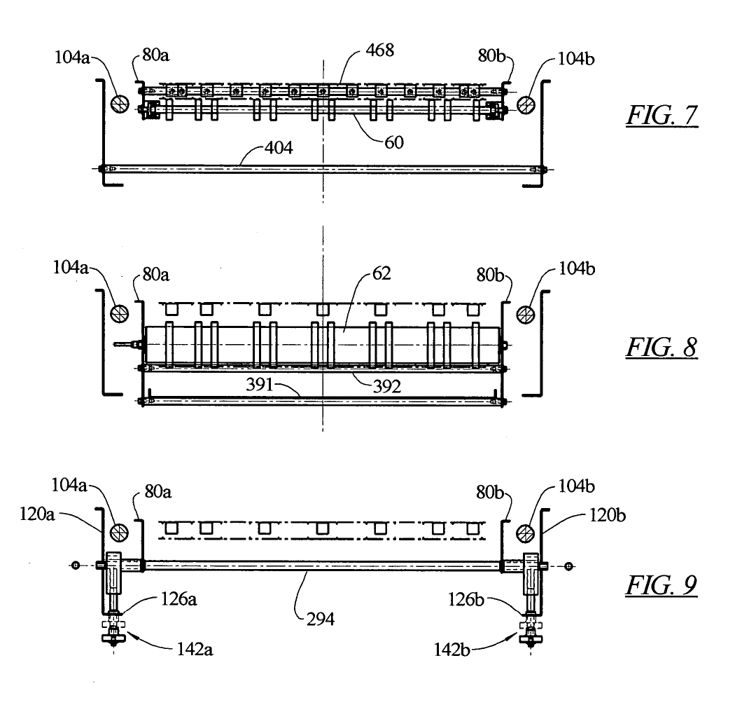

As shown in FIG. 9, the elevation adjustment assemblies 142a, 142b support a rod 294 that supports a front portion of the sidewalls 80a, 80b of the inside frame.

Referring to FIG. 4C, the height adjustment assemblies 140a, 140b, 142a, 142b can be independently adjusted to level the conveyor 46. A series of markings or gradations 295 is provided at each height adjustment assembly. The gradations can be marked off at ¼ inch increments. A corresponding mark on the yoke 266, visible through an opening in the respective sidewall 120a, 120b can be used to set the elevation.

The rear toggle assembly 49 acts to lower the rear end of the inside frame 80 with respect to the outside frame 120, and effectively raise the discharge end 47, by pivoting the inside frame 80 about the rod 294. In this way, the front frame 72 is pivoted upward and can slide over an adjacent piece of equipment, such as the conveyor 48 shown in FIG. 1, for maintenance, cleaning, repair or retooling, particularly of the knock out area of the apparatus 20.

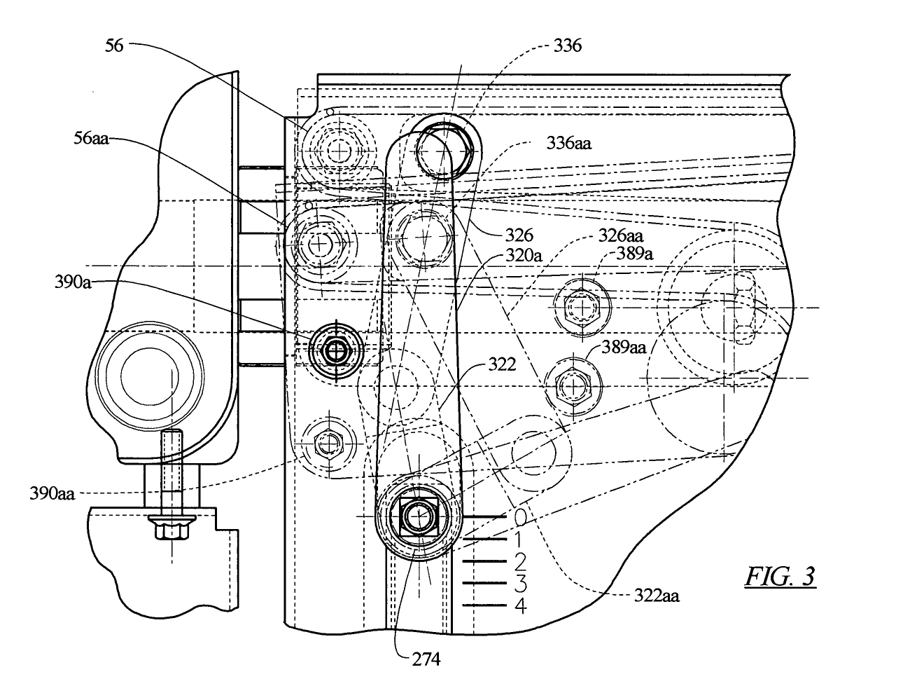

The rear toggle assembly 49 is shown in detail in FIGS. 3 and 6. The rear toggle assembly 49 is configured in mirror image fashion across a longitudinal vertical center plane of the conveyor. The assembly includes levers 320a, 320b on opposite sides of the conveyor 46. Each lever is rigidly connected to an end of the rod 274 by use of a square peg or by a key arrangement, or other arrangement such that turning the lever turns the rod 274. A first link 322 is also fixedly connected to the rod by a keying arrangement or other arrangement, such that turning the rod 274 swings the first link 322 about the centerline of the rod 274. The first link 322 is pivotally connected to a second link 326 at a first end thereof, the second link being pivotally connected to a support rod 336 at a second end thereof. The support rod 336 supports the inside frame 80.

As shown in FIG. 3, when the lever 320a is turned up, the first and second links are substantially vertical, and slightly over center to be locked in place. The support rod 336 is at a relatively high elevation. When the lever is turned down to the position indicated as 320aa, the links 322 and 326 are to an extent folded together to the positions indicated as 322aa, 326aa, and the elevation of the support rod 336 is lowered to the position indicated as 336aa. When the support rod 336 is lowered, the discharge end 47 of the conveyor is raised as the conveyor pivots. This would be a position wherein the conveyor can be slid out longitudinally, using the front toggle assembly 170 so that access is available to the knock out cup area.

Stops are provided to limit the counterclockwise rotary movement of the levers 320a, 320b to the vertical position shown in FIG. 3 and to limit the clockwise rotation of the levers 320a, 320b to the phantom position of the levers 320a, 320b shown in FIG. 3 as 320aa. Particularly, tubular end portions 390a, 390b of a strut 390, each located outside a sidewall 80a, 80b, form one stop. Short rods 389a, 389b arranged on respective sidewalls 80a, 80b form the other stop.

FIG. 3 illustrates components of the conveyor in an operating (elevated) and maintenance (lowered) position. The stop 390a is shown in its elevated position, and in its lowered position indicated as 390aa. The rear roller 56 is shown in its elevated position, and in its lowered position indicated as 56aa. The stop 389a is shown in its elevated operating position, and in its lowered maintenance position, indicated as 389aa where it engages the link 326 shown in its folded position as 326aa.

The figures also illustrate miscellaneous structural struts that rigidify the inside frame between the opposite sidewalls 80a, 80b. Each strut includes a solid rod, spacer or tube between the sidewalls and end fasteners engageable into ends of the tube to connect the tube at opposite ends to the sidewalls 80a, 80b. The struts are marked 390, 391, 392, 393, 408 and 468 shown in FIGS. 4C, 5, 6 and 8. When a solid rod strut is used, the ends of the strut are beveled to form a reduced diameter end portion adjacent a shoulder. The shoulder is pressed against the inside surface of the respective sidewall and the reduced diameter end portion fits closely into a hole through the sidewall. A fastener then clamps the sidewall between a washer on an outside and a shoulder on the inside of the sidewall. The fastener is threaded into a tapped hole on an end of the rod. In the case of the strut 390 the tubular end portions are fit between the washer and the outside of the respective sidewall 80a, 80b.

The figures also illustrate miscellaneous structural struts that rigidify the outside frame 120 between the opposite sidewalls 120a, 120b. Each strut includes a solid rod, spacer or tube between the sidewalls and end fasteners engageable into ends of the tube to connect the tube at opposite ends to the sidewalls 120a, 120b. When a solid rod strut is used, the ends of the strut are beveled to form a reduced diameter end portion adjacent a shoulder. The shoulder is pressed against the inside surface of the respective sidewall and the reduced diameter end portion fits closely into a hole through the sidewall. A fastener then clamps the sidewall between a washer on an outside and a shoulder on the inside of the sidewall. The fastener is threaded into a tapped hole on an end of the rod. The struts are marked 404, 406 shown in FIGS. 4C, 6, and 7.

The struts 408 and 391 support a drip shield 430 that directs drippings into a recovery trough 434 (FIG. 2).

The figures also illustrate a structural strut 440 that rigidifies the front frame 72 between the opposite sidewalls 72a, 72b. The strut includes a spacer or tube between the sidewalls and end fasteners engageable into ends of the tube to connect the tube at opposite ends to the sidewalls 72a, 72b. The strut 440 is shown in FIGS. 4A, 11 and 12.

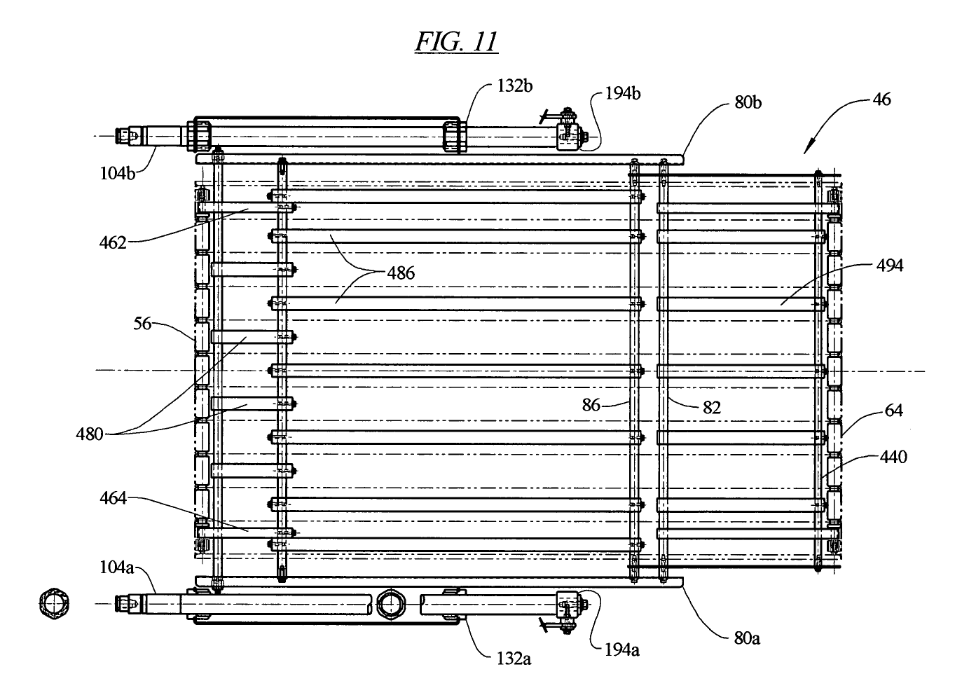

As illustrated in FIGS. 10 and 11, the rear roller 56 is journaled by longitudinal conveyor support members 462, 464 that are supported by support rod 336 and by strut 468. The rod 336 and strut 468 penetrate through the members 462, 464. The members 462, 464 are fixed to the strut 468 by fasteners. The rod 336 and strut 468 also penetrate through a plurality of conveyor supports 480 in like fashion. Longer conveyor supports 486 extend from the strut 468 to the angle set strut 86 and are fixed at both ends by fasteners. Further conveyor supports 494 are captured by being penetrated at one end by the pivot strut 82 and are fastened at an opposite end by fasteners to the strut 440.

The conveyor belt 52 moves over and is supported by the members and supports 462, 464, 480, 486, 494.

Because the rear roller 56 is not journalled directly to the sidewalls 80a, 80b, but journalled through intervening supports 462, 464, the angle to horizontal of the short supports 480 and the members 462, 464 can be set independently of the longer supports 486 by varying the relative angle of the members and supports 462, 464, 480 with respect to the supports 486 at the strut 468. Thus, the members 462, 464 and supports, 480, in the location where the patties land from the mold plate, can be kept level, notwithstanding the angle of the remaining portion of the conveyor top surface.

Also, as the angle of the front frame 72 is set with respect to the inside frame 80, the supports 494 are set at an angle to the longer supports 486 such that the top conveying surface can be set in three distinct planes: an input area, an intermediate area, and an output area.

From the foregoing, it will be observed that numerous variations and modifications may be effected without departing from the spirit and scope of the invention. It is to be understood that no limitation with respect to the specific apparatus illustrated herein is intended or should be inferred.

1. An output conveyor for a food product-producing apparatus, comprising:
an outer conveyor frame;
an inner conveyor frame;
a front roller;
a rear roller;
said front and rear rollers rotatably supported on said inner conveyor frame;
an endless belt wrapped around said front and rear rollers, said endless belt providing a top conveying surface;
wherein said inner conveyor frame is supported on said outer conveyor frame by adjustable connections wherein an elevation of said endless belt at least at one end thereof can be changed.

2. The conveyor according to claim 1, wherein an angle of said top conveying surface at said one end is changed to change said elevation.

3. The conveyor according to claim 1, wherein said outer frame conveyor frame comprises two horizontal rods, said horizontal rods configured to be attached to said food product-producing apparatus to support said conveyor in cantilever fashion thereto.

4. The conveyor according to claim 1, wherein said connections comprise toggle adjusters that fix the relative elevation of said inner conveyor to said outer conveyor at said toggle adjusters between an elevated orientation and a lowered orientation.

5. The conveyor according to claim 1, wherein said conveyor comprises a support surface beneath said top conveying surface of said endless belt arranged between said front and rear rollers, and a second support surface beneath said top conveying surface of said endless belt arranged between said first portion and said front roller, said first and second support surfaces being in two different planes such that said top conveying surface of said endless belt conveys in two different planes.

6. The conveyor according to claim 5 further comprising a third support surface beneath said top conveying surface of said endless belt, said third support surface arranged between said second support surface and said front roller, such that the top conveying surface of said endless belt is arranged in three distinct planes.

7. The conveyor according to claim 1, wherein said outer conveyor frame comprises two horizontal rods, said horizontal rods configured to be attached to said food product-producing apparatus to support said conveyor in cantilever fashion thereto, and wherein said inner conveyor frame is slidable along said rods away from said food product-producing apparatus.

8. The conveyor according to claim 7 comprising at least one articulated handle operatively connected between said inner frame and said rods, said articulated handle foldable when said inner frame is slid away from said product-producing apparatus and unfolded to an over center position to releasably lock said inner frame in its operating position.

9. The conveyor according to claim 8 further comprising a guard at least partially enclosing an output end of said food product output apparatus, said guard pivotally connected to an end of said articulated handle, and a mid pivot of said articulated handle comprising stops such that said guard is supported in its open position on said stops, above said top conveying surface.

10. A patty forming and conveying assembly comprising:
a reciprocating mold plate patty-forming apparatus comprising a frame, a mold plate driven to reciprocate on said frame, said mold plate having a plurality of patty-forming cavities therethrough, a pressurized food product delivery system for delivering pressurized food product into said cavities to form patties when said mold plate is in a fill position, and a plurality of knockout plungers arranged to reciprocate vertically to displace patties from said cavities, when said mold plate is in a discharge position;
a conveyor assembly comprising two spaced-apart horizontally disposed rods fixed at base ends to said frame, and a conveyor frame slidable along said rods, an endless belt conveyor carried by said frame, said endless belt conveyor slidable from a position wherein an input region of said conveyor is beneath said knockout plungers, to a position wherein said input region of said conveyor is at a horizontal distance from said knockout plungers.

11. The assembly according to claim 10, wherein said conveyor frame includes an inner frame and an outer frame, said outer frame carried by said rods, said endless belt conveyor carried by said inner frame, and comprising at least one adjuster, an elevation of at least one portion of said inner frame is adjustable with respect to the outer frame by manipulation of said adjuster.

12. The assembly according to claim 11, wherein said adjuster comprises a lever mechanism that sets the elevation of a back portion of said inner frame between an elevated position and a lowered position.

13. The assembly according to claim 12, wherein said inner frame is pivotally connected to said outer frame at a pivot position distant from said adjuster, manipulating said lever to set the back portion of said inner frame to the lowered position raises a front portion of said inner frame about said pivot position.

14. The assembly according to claim 11, wherein said at least one adjuster comprises two laterally spaced-apart front adjusters and two laterally spaced-apart rear adjusters, manipulation of said front and rear adjusters sets an elevation and level of said inner frame with respect to said outer frame.

15. The assembly according to claim 14, wherein each adjuster comprises a threaded rod connected to said outer frame, and a yoke with a threaded hole that is engaged by said threaded rod, said yoke carrying a portion of said inner frame, the extent of threaded engagement of said rod in said yoke sets the elevation of said inner frame with respect to said outer frame at said adjuster.
